(19) United States
(12) Patent Application Publication
(10) Pub. No.: US 2015/0373527 A1
(43) Pub. Date: Dec. 24, 2015

(54) USER EQUIPMENT DETACH INDICATION TO HOME SUBSCRIBER SERVER

(71) Applicant: NOKIA SOLUTIONS AND NETWORKS OY, Espoo (FI)

(72) Inventors: Joanna Pauliina JOKINEN, Espoo (FI); Paula Hannele SIREN, Vantaa (FI); Mika Juhani NEVANDER, Vantaa (FI)

(21) Appl. No.: 14/765,075

(22) PCT Filed: Jan. 31, 2014
(86) PCT No.: PCT/EP2014/051971

§ 371 Date: Jul. 31, 2015

Related U.S. Application Data
(60) Provisional application No. 61/759,610, filed on Feb. 1, 2013.

(51) Int. Cl. H04W 8/04; H04W 60/06; H04W 8/12

(52) U.S. Cl. CPC H04W 8/04; H04W 8/12; H04W 60/06; H04W 88/02

(57) ABSTRACT

In certain communication systems, such as wireless communication systems, there may be benefit to knowing a user equipment's registration status. For example, there may be benefit to observing a user equipment's registration status via a home subscriber server, including whether the user equipment is attached/detached. The communication system may be for example, a long term evolution (LTE) of the third generation partnership project (3GPP). A method can include determining, in a mobility node, that a user equipment is currently deregistered. The method can also include notifying a subscriber server that the user equipment is currently deregistered, responsive to the determination that the user equipment is currently deregistered.

### CROSS-REFERENCE TO RELATED APPLICATION

This application is related to and claims the benefit and priority of U.S. Provisional Patent Application No. 61/759,610, filed Feb. 1, 2013, the entirety of which is hereby incorporated herein by reference.

### BACKGROUND

1. Field

In certain communication systems, such as wireless communication systems, there may be benefit to knowing a user equipment's registration status. For example, there may be benefit to observing a user equipment's registration status via a home subscriber server, including whether the user equipment is attached/detached. The communication system may be for example, a long term evolution (LTE) of the third generation partnership project (3GPP).

2. Description of the Related Art

A home subscriber server may conventionally be unable to learn that the user equipment is deregistered in mobility management entity/serving general packet radio services (GPRS) support node (MME/SGSN). Moreover, services may utilize user equipment reachability procedure provided by the home subscriber server.

### SUMMARY

According to a first embodiment, a method can include determining, in a mobility node, that a user equipment is currently deregistered. The method can also include notifying a subscriber server that the user equipment is currently deregistered, responsive to the determination that the user equipment is currently deregistered.

In a variation, the mobility node can include at least one of a mobility management entity or a serving general packet radio service support node.

In a variation, the subscriber server can include a home subscriber server.

In a variation, the user equipment can be deregistered by a detach or inter radio access technology mobility.

In a variation, the notifying can include sending a notify request message with a flag and/or attribute value pair that indicates that the user equipment is deregistered.

In a variation, the notifying can be controlled either based on a user equipment subscription or based on the mobility node.

According to a second embodiment, a method may include receiving, in a subscriber server, a notification from a mobility node that a user equipment is currently deregistered. The method may also include updating the subscriber server to reflect a status that the user equipment is deregistered, based on the notification.

In a variation, the method also includes making the status that the user equipment is deregistered available to services provided by other nodes.

In a variation the mobility node can include at least one of a mobility management entity or a serving general packet radio service support node.

In a variation, the subscriber server can include a home subscriber server.

In third and fourth embodiments, a computer-readable medium, such as a non-transitory computer readable medium can be encoded with instructions that, when executed, perform the methods according to the above-described first and second embodiments in any of their variations.

According to a fifth embodiment, an apparatus can include at least one processor and at least one memory including computer program code. The at least one memory and the computer program code can be configured to, with the at least one processor, cause the apparatus at least to determine, in a mobility node, that a user equipment is currently deregistered. The at least one memory and the computer program code can also be configured to, with the at least one processor, cause the apparatus at least to notify a subscriber server that the user equipment is currently deregistered, responsive to the determination that the user equipment is currently deregistered.

In a variation, the mobility node can include at least one of a mobility management entity or a serving general packet radio service support node.

In a variation, the subscriber server can include a home subscriber server.

In a variation, the user equipment is deregistered by a detach or inter radio access technology mobility.

In a variation, the at least one memory and the computer program code can be configured to, with the at least one processor, cause the apparatus at least to notify by sending a notify request message with a flag and/or attribute value pair that indicates that the user equipment is deregistered.

In a variation, the notification is controlled either based on a user equipment subscription or based on the mobility node.

According to a sixth embodiment, an apparatus can include at least one processor and at least one memory including computer program code. The at least one memory and the computer program code can be configured to, with the at least one processor, cause the apparatus at least to receive, in a subscriber server, a notification from a mobility node that a user equipment is currently deregistered. The at least one memory and the computer program code can also be configured to, with the at least one processor, cause the apparatus at least to update the subscriber server to reflect a status that the user equipment is deregistered, based on the notification.

In a variation, the at least one memory and the computer program code can be configured to, with the at least one processor, cause the apparatus at least to make the status that the user equipment is deregistered available to services provided by other nodes.

In a variation, the mobility node can include at least one of a mobility management entity or a serving general packet radio service support node.

In a variation, the subscriber server can include a home subscriber server.

According to a seventh embodiment, an apparatus can include determining means for determining, in a mobility node, that a user equipment is currently deregistered. The apparatus can also include notifying means for notifying a subscriber server that the user equipment is currently deregistered, responsive to the determination that the user equipment is currently deregistered.

In a variation, the mobility node can include at least one of a mobility management entity or a serving general packet radio service support node.

In a variation, the subscriber server can include a home subscriber server.

In a variation, the user equipment is deregistered by a detach or inter radio access technology mobility.

In a variation, the notifying comprises sending a notify request message with a flag and/or attribute value pair that indicates that the user equipment is deregistered.

In a variation, the notifying is controlled either based on a user equipment subscription or based on the mobility node.

According to an eighth embodiment, an apparatus can include receiving means for receiving, in a subscriber server, a notification from a mobility node that a user equipment is currently deregistered. The apparatus can also include updating means for updating the subscriber server to reflect a status that the user equipment is deregistered, based on the notification.

In a variation, the apparatus can include status means for making the status that the user equipment is deregistered available to services provided by other nodes.

In a variation, the mobility node can include at least one of a mobility management entity or a serving general packet radio service support node.

In a variation, the subscriber server can include a home subscriber server.

According to a ninth embodiment, a system can include a first apparatus and a second apparatus. The first apparatus can include determining means for determining, in a mobility node, that a user equipment is currently deregistered. The first apparatus can also include notifying means for notifying a subscriber server that the user equipment is currently deregistered, responsive to the determination that the user equipment is currently deregistered. The second apparatus can include receiving means for receiving, in the subscriber server, a notification from the mobility node that the user equipment is currently deregistered. The second apparatus can also include updating means for updating the subscriber server to reflect a status that the user equipment is deregistered, based on the notification.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates a system according to certain embodiments.

### DETAILED DESCRIPTION

Immediate purging of a mobility management entity/ serving general packet radio services (GPRS) support node (MME/SGSN) is one way that a home subscriber server

(HSS) would be able to immediately determine whether the user equipment (UE) is detached or not. Immediate purging, however, may lead to additional signaling when the user equipment attaches again. The user equipment data would not be in MME/SGSN anymore and thus the entire subscription data may need to be re-fetched from a home subscriber server. Furthermore, an update location answer (ULA) message size may be bigger. The MME/SGSN may also need to re-authenticate the user equipment at the new attach and with that both non-access stratum (NAS) signaling dialog and authentication information request (AIR)/authentication information answer (AIA) in interface S6a may be needed.

The same issue may apply to inter-system mobility if purge/location update needs to be sent to home subscriber server to indicate user equipment registration status in the MME/SGSN. Moreover, services utilizing home subscriber server may need to utilize a significant amount of signaling when trying to contact the user equipment.

According to certain embodiments, when user equipment is deregistered in MME/SGSN, the MME/SGSN can tell the home subscriber server that the user equipment is currently deregistered. This telling the home subscriber server may be done in a variety of ways, such as by S6a/S6d Notify Request (NOR) message with a new specific flag/attribute value pair (AVP). The deregistering can be done in a variety of ways, such as, for example, by detach or inter radio access technology (RAT) mobility.

Sending of the detach indication can be controlled either on a user equipment subscription level or on an MME/SGSN level.

Certain embodiments may produce a variety of benefits. For example, certain embodiments may reduce the amount of signaling needed. Data of a user equipment can be kept in MME/SGSN and immediate purge with re-fetching the user equipment data and re-authentication may be unnecessary. Also the amount of signaling between the home subscriber server and services utilizing the home subscriber server can be reduced. Moreover, the home subscriber server may make further use of the information that the user equipment is deregistered for other purposes.

Certain embodiments may also make the home subscriber server aware of whether idle state signaling reduction (ISR) is activated in the network. In case ISR is not activated, the detach indication can be sent from a previous node during inter-RAT mobility. Thus the home subscriber server may not have to try to reach the user equipment via both/all radio accesses.

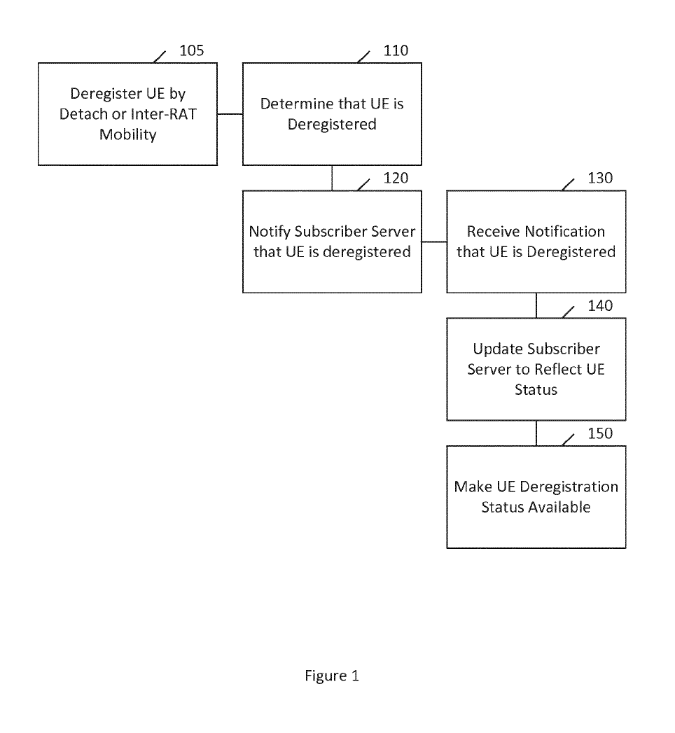

FIG. 1 illustrates a method according to certain embodiments. The method of FIG. 1 may be performed by a first device such as, for example, a mobility node, such as a MME, SSGN, or combination thereof, and a second device, such as, for example, a subscriber server, such as a home subscriber server.

The method may include, at 110, determining, in a mobility node, that a user equipment is currently deregistered. The method can also include, at 105, deregistering the user equipment by a detach or inter radio access technology mobility. This deregistration may be performed by or in connection with another network element.

The method may also include, at 120, notifying a subscriber server that the user equipment is currently deregistered, responsive to the determination that the user equipment is currently deregistered. The notifying may be performed by the mobility node, which may be at least one of a mobility management entity or a serving general packet radio service support node. The subscriber server may be a home subscriber server.

The notifying can include sending a notify request message with a flag and/or attribute value pair that indicates that the user equipment is deregistered. The notifying can be controlled either based on a user equipment subscription or based on the mobility node, such as depending on the details of the user equipment or depending on which mobility node is being used.

The method can also include, at 130, receiving, in a subscriber server, a notification from a mobility node that a user equipment is currently deregistered. This can be received directly or indirectly from the mobility node. The method can further include, at 140, updating the subscriber server to reflect a status that the user equipment is deregistered, based on the notification. The method can additionally include, at 150, making the status that the user equipment is deregistered available to services provided by other nodes.

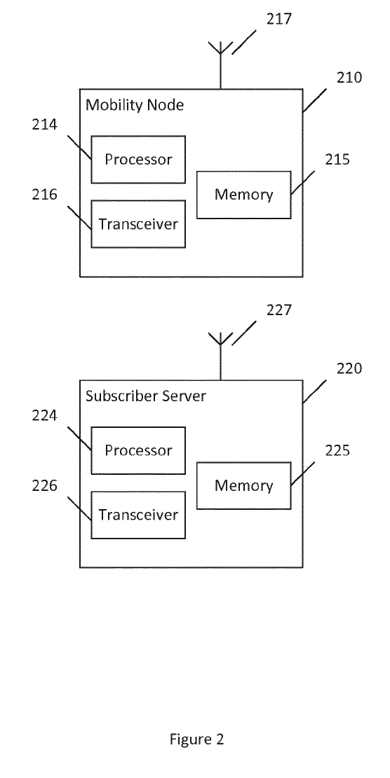

FIG. 2 illustrates a system according to certain embodiments of the invention. In one embodiment, a system may comprise several devices, such as, for example, mobility node 210 and subscriber server 220. The system may comprise more than one subscriber server 220 and more than one mobility node 210, although only one of each is shown for the purposes of illustration. A subscriber server 220 may be, for example, a home subscriber server, or a visitor subscriber server. A mobility node can be an MME, SGSN, or any combination thereof. Each of these devices may comprise at least one processor, respectively indicated as 214 and 224. At least one memory may be provided in each device, and indicated as 215 and 225, respectively. The memory may comprise computer program instructions or computer code contained therein. One or more transceiver 216 and 226 may be provided, and each device may also comprise an antenna, respectively illustrated as 217 and 227. Although only one antenna each is shown, many antennas and multiple antenna elements may be provided to each of the devices. Other configurations of these devices, for example, may be provided. For example, mobility node 210 and subscriber server 220 may be additionally or solely configured for wired communication and in such a case antennas 217 and 227 may illustrate any form of communication hardware, without being limited to merely an antenna.

Transceivers 216 and 226 may each, independently, be a transmitter, a receiver, or both a transmitter and a receiver, or a unit or device that may be configured both for transmission and reception. Network cards may, for example, be used in connection with wired communication.

Processors 214 and 224 may be embodied by any computational or data processing device, such as a central processing unit (CPU), application specific integrated circuit (ASIC), or comparable device. The processors may be implemented as a single controller, or a plurality of controllers or processors.

Memories 215 and 225 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language.

The memory and the computer program instructions may be configured, with the processor for the particular device, to cause a hardware apparatus such as mobility node 210 and subscriber server 220, to perform any of the processes described above (see, for example, FIG. 1). Therefore, in certain embodiments, a non-transitory computer-readable medium may be encoded with computer instructions that, when executed in hardware, may perform a process such as one of the processes described herein. Alternatively, certain embodiments of the invention may be performed entirely in hardware.

Furthermore, although FIG. 2 illustrates a system including a mobility node 210 and a subscriber server 220, embodiments of the invention may be applicable to other configurations, and configurations involving additional elements, as illustrated and discussed herein. For example, the functions of the mobility node 210 and a subscriber server 220 can be combined into a single network element or can be distributed across multiple network elements.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### GLOSSARY

UE User Equipment

HSS Home Subscriber Server

MME Mobility Management Entity

SGSN Serving GPRS Support Node

GPRS General Packet Radio Service

NOR Notify Request

ULA Update Location Answer

AVP Attribute Value Pair

LTE Long Term Evolution of 3GPP

3GPP Third Generation Partnership Project

ISR Idle state Signaling Reduction

NAS Non-Access Stratum

AIR Authentication Information Request

AIA Authentication Information Answer

1. A method, comprising:
determining, in a mobility node, that a user equipment is currently deregistered; and
notifying a subscriber server that the user equipment is currently deregistered, responsive to the determination that the user equipment is currently deregistered.

2. The method of claim 1, wherein the mobility node comprises at least one of a mobility management entity or a serving general packet radio service support node.

3. The method of claim 1, wherein the subscriber server comprises a home subscriber server.

4. The method of claim 1, wherein the user equipment is deregistered by a detach or inter radio access technology mobility.

5. The method of claim 1, wherein the notifying comprises sending a notify request message with a flag and/or attribute value pair that indicates that the user equipment is deregistered.

6. The method of claim 1, wherein the notifying is controlled either based on a user equipment subscription or based on the mobility node.

7. A method, comprising:
receiving, in a subscriber server, a notification from a mobility node that a user equipment is currently deregistered; and
updating the subscriber server to reflect a status that the user equipment is deregistered, based on the notification.

8. The method of claim 7, further comprising:
making the status that the user equipment is deregistered available to services provided by other nodes.

9. The method of claim 7, wherein the mobility node can include at least one of a mobility management entity or a serving general packet radio service support node.

10. The method of claim 7, wherein the subscriber server comprises a home subscriber server.

11. A non-transitory computer-readable medium encoded with instructions that, when executed in hardware, perform a process, the process comprising the method according to claim 1.

12. A computer program product encoding instructions for performing a process, the process comprising the method according to claim 1.

13. An apparatus, comprising:
at least one processor; and
at least one memory including computer program code,
wherein the at least one memory and the computer program code are configured to, with the at least one processor, cause the apparatus at least to
determine, in a mobility node, that a user equipment is currently deregistered; and
notify a subscriber server that the user equipment is currently deregistered, responsive to the determination that the user equipment is currently deregistered.

14. The apparatus of claim 13, wherein the mobility node comprises at least one of a mobility management entity or a serving general packet radio service support node.

15. The apparatus of claim 13, wherein the subscriber server comprises a home subscriber server.

16. The apparatus of claim 13, wherein the user equipment is deregistered by a detach or inter radio access technology mobility.

17. The apparatus of claim 13, wherein the at least one memory and the computer program code are configured to, with the at least one processor, cause the apparatus at least to notify by sending a notify request message with a flag and/or attribute value pair that indicates that the user equipment is deregistered.

18. The apparatus of claim 13, wherein the notification is controlled either based on a user equipment subscription or based on the mobility node.

19. An apparatus, comprising:
at least one processor; and
at least one memory including computer program code,
wherein the at least one memory and the computer program code are configured to, with the at least one processor, cause the apparatus at least to
receive, in a subscriber server, a notification from a mobility node that a user equipment is currently deregistered; and
update the subscriber server to reflect a status that the user equipment is deregistered, based on the notification.

20. The apparatus of claim 19, wherein the at least one memory and the computer program code are configured to, with the at least one processor, cause the apparatus at least to make the status that the user equipment is deregistered available to services provided by other nodes.

21. The apparatus of claim 19, wherein the mobility node comprises at least one of a mobility management entity or a serving general packet radio service support node.

22. The apparatus of claim 19, wherein the subscriber server comprises a home subscriber server.

23.-33. (canceled)
